(19) United States
(12) Patent Application Publication
(10) Pub. No.: US 2022/0240487 A1
(43) Pub. Date: Aug. 4, 2022

(54) Pet Toy and Sound Generator

(71) Applicant: Bencoo, Inc. DBA ZippyPaws, Chino, CA (US)

(72) Inventor: Jennifer Glaser, Pasadena, CA (US)

(21) Appl. No.: 17/726,331

(22) Filed: Apr. 21, 2022

Related U.S. Application Data
(63) Continuation-in-part of application No. 16/920,995, filed on Jul. 6, 2020, now abandoned.

(51) Int. Cl. A01K 15/02

(52) U.S. Cl. CPC A01K 15/025

(57) ABSTRACT

The present application discloses a pet toy. The pet toy comprises a body and a sound generator. The body comprises a tube hole. The sound generator is passed through the tube hole. The sound generator comprises a tube and a sound maker disposed inside the tube. The sound maker comprises a toning wedge and a reed. The toning wedge comprises at least one fixer. The reed comprises at least one reed tab coupled into the at least one fixer. The sound generator as above is also disclosed.

### CROSS-REFERENCE TO RELATED APPLICATION

This application claims the priority of non-provisional patent application U.S. Ser. No. 16/920,995 filed Jul. 6, 2020 which is expressly incorporated by reference herein in its entirety.

### TECHNICAL FIELD OF THE INVENTION

The present application generally relates to pet toys, and more particularly, to a pet toy and a sound generator.

### BACKGROUND OF THE INVENTION

Generally, an electronic device is built in the pet toy for sound-making. However, it is required for the user to replace the battery frequently. In addition, the leakage of battery may bring contamination and it is also dangerous for the pet. Furthermore, the cost is high since the electronic structure is complicated and easily to be broken.

Another kind of pet toy uses air flow to create sound. However, it is easy to be deformed during high temperature manufacturing processes. Specifically, the sound maker is manufactured under 160° C. of manufacturing process. However, most of them are deformed during the process. As such, the deformed sound maker could not generate the sound which it supposed to have.

Therefore, a need remains for a pet toy and a sound generator to generate sound via an easier, cheaper and not easily deformed way.

### SUMMARY OF THE INVENTION

The present application discloses a pet toy and a sound generator to generate sound via an easier, cheaper and not easily deformed way.

The pet toy comprises a body and a sound generator. The body comprises a tube hole. The sound generator is passed through the tube hole. The sound generator comprises a tube and a sound maker disposed inside the tube. The sound maker comprises a toning wedge and a reed. The toning wedge comprises at least one fixer. The reed comprises at least one reed tab coupled into the at least one fixer.

In various exemplary embodiments, wherein the toning wedge comprises two fixers and the reed comprises two reed tabs. Specifically, the fixers are located at middle of sides of the toning wedge correspondingly, wherein the reed tabs are located at middle of sides of the reed correspondingly.

In various exemplary embodiments, wherein the tube comprises a plate and a sleeve. The plate comprises a hole and the sleeve is coupled to the plate.

In various exemplary embodiments, wherein the tube further comprises at least one extension coupled to the sleeve. Specifically, the tube comprises two extensions. At least one extension gap located between the extensions. In present application, there are two gaps located between the extensions.

In various exemplary embodiments, wherein one of the extension comprises at least one recess.

In various exemplary embodiments, wherein the tube further comprises a ridge located between the sleeve and the extensions.

In various exemplary embodiments, wherein the ridge comprises a ridge gap.

The present application also discloses the sound generator as above. Specifically, the sound generator comprises a tube and a sound maker. The sound maker is disposed inside the tube and comprises a toning wedge and a reed. The toning wedge comprises at least one fixer. The reed comprises at least one reed tab coupled into the at least one fixer.

In various exemplary embodiments, wherein the toning wedge comprises two fixers and the reed comprises two reed tabs.

In various exemplary embodiments, wherein the tube comprises a plate and a sleeve. The plate comprises a hole and a sleeve is coupled to the plate.

In various exemplary embodiments, wherein the tube further comprises at least one extension coupled to the sleeve. In the present application, the tube comprises two extensions. Two gaps are located between the extensions.

In various exemplary embodiments, wherein one of the extension comprises at least one recess.

In various exemplary embodiments, wherein the tube further comprises a ridge located between the sleeve and the at least one extension.

Based on the above, the present application provides a more stable sound maker by coupling the fixers to the toning wedge and coupling the reed tabs to the reed, allowing the reed tabs to be fixed stably with the toning wedge. In current market, the reed is generally coupled to the toning wedge by using a sleeve to tie and lock them together. The toning wedge and the reed are easily to be separated simply by shaking the sound maker.

In addition, the structure of the tube could sustain high temperature manufacture process. As such, the sound may not be changed and will keep the same as it should be even after high-temperature manufacturing process because the tube is not easily deformed.

Numerous other advantages and features of the present application will become readily apparent from the following detailed description of disclosed embodiments, from the claims and from the accompanying drawings.

### BRIEF DESCRIPTION OF THE DRAWINGS

The objects, features and advantages of the present application will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 shows a pet toy of the present application.

FIGS. 2-3 show exploded views of the pet toy of the present application.

FIG. 4 shows a cross-sectional view of the pet toy of the present application.

FIGS. 5-6 show perspective views of a sound generator of the pet toy of the present application

### DETAILED DESCRIPTION OF DISCLOSED EMBODIMENTS

Reference will now be made in detail to the present representative embodiments of the present application, examples of which are illustrated in the accompanying drawings. Wherever possible, the same reference numbers are used in the drawings and the description to refer to the same or like parts.

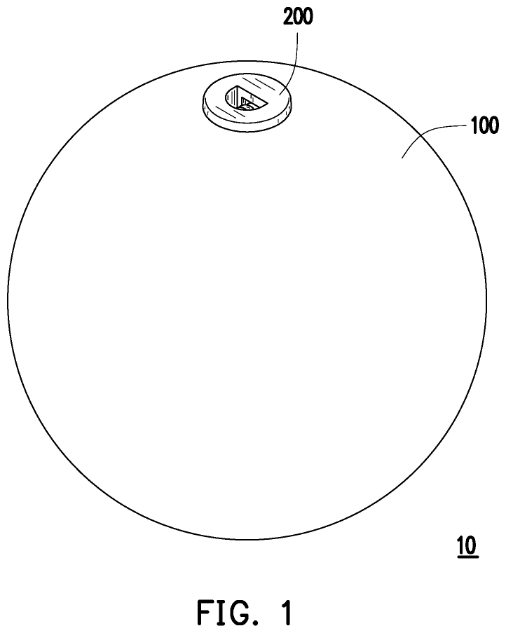

FIG. 1 shows a pet toy 10 of the present application.

Referring to FIG. 1, the pet toy 10 of the present application comprises a body 100 and a sound generator 200. The body 100 comprises a tube hole 110. The body 100 in the present application comprises flexible material. As such, the user may change the shape of the body 100 to change the air flow passing through the sound generator 200. The body 100 of the present application is round as an example. However, the shape of the body 100 may be modified as long as the air flow passing through the sound generator 200 may be changed.

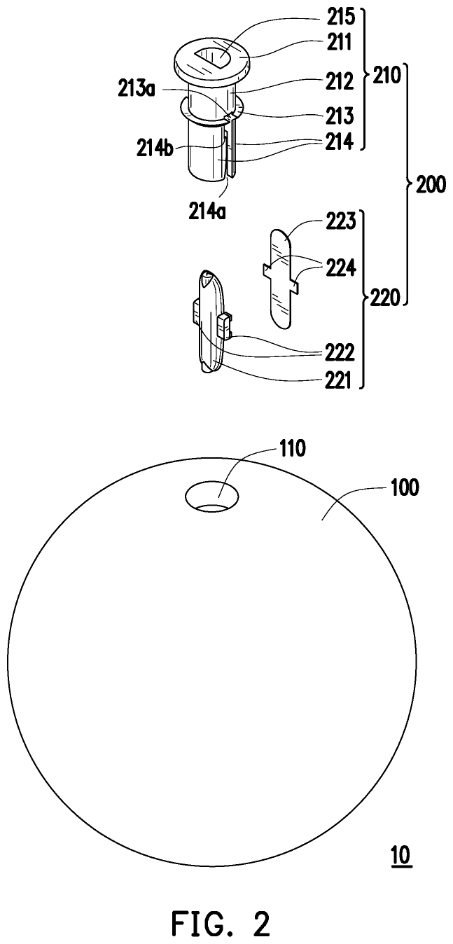

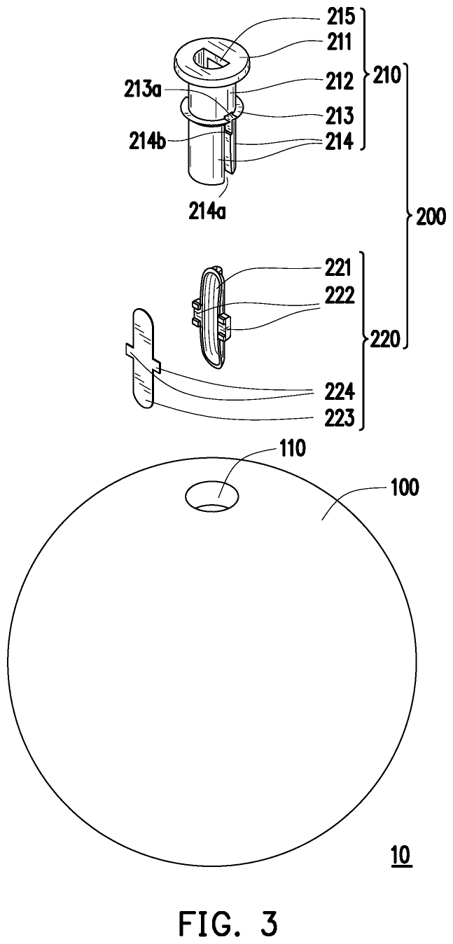

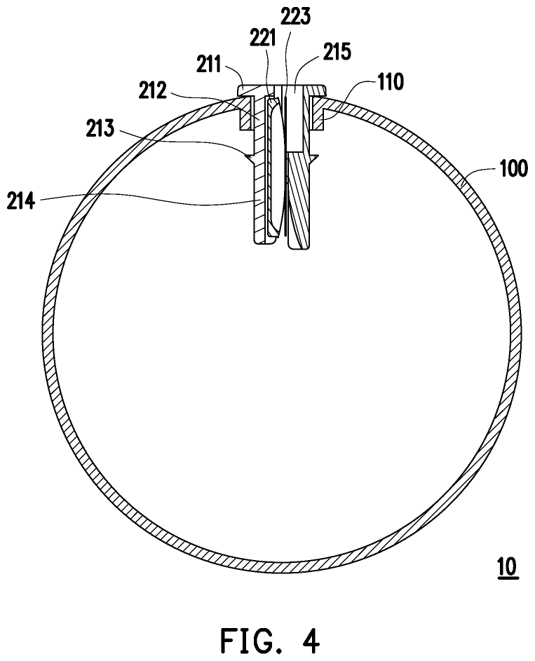

FIGS. 2-3 show exploded views of the pet toy 10 of the present application. FIG. 4 shows a cross-sectional view of the pet toy 10 of the present application.

Referring to FIGS. 2-4, the sound generator 200 comprises a tube 210 and a sound maker 220. The tube 210 comprises a plate 211, a sleeve 212, a ridge 213 and at least one extension 214.

The plate 211 comprises a hole 215. The hole 215 is semicircular as an example but is not limited. The plate 211 in the present application is round as an example but is not limited either.

The sleeve 212 is coupled to the plate 211. The sleeve 212 is hollow and the air flow is capable of flowing through the hole 215 and the hollow sleeve 212.

The details of the ridge 213 will be described later with the at least one extension 214.

The sound generator 200 of the present application comprises two extensions 214 as an example but is not limited thereto. At least one extension gap 214a is located between the extensions 214. In the present application, there are two extension gaps 214a located between the two extensions 214. One of the extension 214 comprises a recess 214b. In another example, each of the two extensions 214 may comprise recess 214b as well.

The ridge 213 is coupled between the sleeve 212 and the extensions 214. The ridge 213 comprises a ridge gap 213a. The ridge gap 213, the recess 214b and the extension gap 214a are located on the same line as shown in FIGS. 2-3.

In the present application, the sleeve 212 and the extensions 214 together form a hollow and cylindrical shape. However, the present application is not limited thereto as long as the air flow may pass through the hole 215, the sleeve 212 and the middle portion between the extensions 214.

In the present application, the plate 211, the sleeve 212, the ridge 213 ad the extensions 214 are molded integrally as an example but is not limited.

The above structure of the tube 210 could sustain high temperature manufacture process. As such, the sound may not be changed and will keep the same as it should be even after high-temperature manufacturing process because the tube 210 of the present application is not easily deformed.

The sound maker 220 of the present application comprises a toning wedge 221, at least one fixer 222, a reed 223 and at least one reed tab 224.

The toning wedge 221 is curved. The reed 223 is vibrated toward the toning wedge 221 when air volume inside the tube 210 is changed. As such, the sound may be generated.

The sound maker 220 comprises two fixers 222 and two reed tabs 224 in the present application as an example but is not limited. Specifically, the fixers 222 are molded integrally with the toning wedge 221 in the present application as an example. However, the present application is not limited as long as the fixers 222 could fix the reed 223 with the toning wedge 221. The fixers 222 are located at middle of sides of the toning wedge 221 correspondingly as an example.

The reed tabs 224 are molded integrally with the reed 223 in the present application as an example. However, the present application is not limited thereto. The reed tabs 224 are located at middle of sides of the reed 223 correspondingly as an example.

By the above structure the reed tabs 224 may be coupled to the fixers 222 by inserting the reed tabs 224 into recesses of the fixers 222.

In current market, the reed is generally coupled to the toning wedge by using a sleeve to tie and lock them together. The toning wedge and the reed are easily to be separated simply by shaking the sound maker. By the above structure, the present application provides a more stable sound maker 220 by coupling the fixers 222 to the toning wedge 221 and coupling the reed tabs 224 to the reed 223, allowing the reed tabs 224 to be fixed stably with the toning wedge 221.

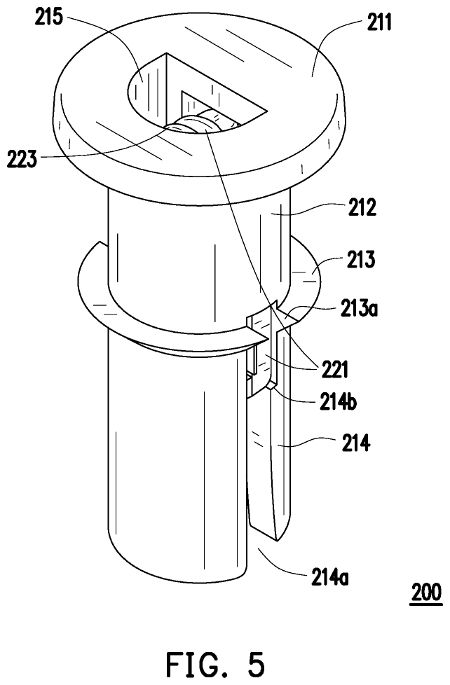

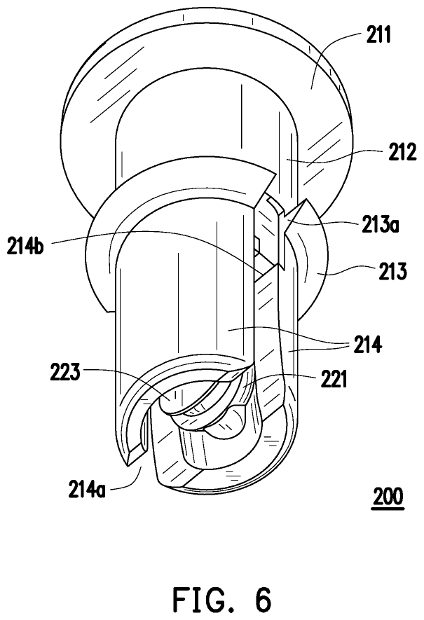

FIGS. 5-6 show perspective views of a sound generator 200 of the pet toy 10 of the present application

As shown in FIGS. 5-6, after coupling the reed 223 with the toning wedge 221 by inserting the reed tabs 224 (referring to FIGS. 2-3) into the recesses of the fixers 222 (referring to FIGS. 2-3), the sound maker 220 could be inserted into the tube 210. Specifically, the fixer 222 and the reed tabs 224 are locked at the recess of one of the extension 214. The extension 214 locks the toning wedge 221 and the reed 223 by fixing the fixers 222 and the reed tabs 224. As such, the sound maker 220 is fixed at the fixed location and is not easily to fallen down.

Based on the above, the present application provides a more stable sound maker 200 by inserting the reed tabs 224 into the recess of the fixers 222, allowing the reed tabs 224 to be fixed more stably to the toning wedge 221.

In addition, the structure of the tube 210 could sustain high temperature manufacture process. Specifically, the combination of the plate 211, the sleeve 212, the ridge 213 and the extensions 214 provide a more stable structure. As such, the sound may not be changed and will keep the same as it should be even after high-temperature manufacturing process because the tube 210 is not easily deformed.

It will be apparent to those skilled in the art that various modifications and variations can be made to the structure of the present application without departing from the scope or spirit of the present application. In view of the foregoing, it is intended that the present application cover modifications and variations of this application provided they fall within the scope of the following claims and their equivalents.

What is claimed is:

1. A pet toy, comprising:
a body comprising a tube hole; and
a sound generator passed through the tube hole, wherein the sound generator comprises:
a tube; and
a sound maker disposed inside the tube, wherein the sound maker comprises:
a toning wedge comprising at least one fixer; and
a reed comprises at least one reed tab coupled into the at least one extension.

2. The pet toy as claimed in claim 1, wherein the toning wedge comprises two fixers and the reed comprises two reed tabs.

3. The pet toy as claimed in claim 2, wherein the fixers are located at middle of sides of the toning wedge correspondingly, wherein the reed tabs are located at middle of sides of the reed correspondingly.

4. The pet toy as claimed in claim 1, wherein the tube comprises
a plate comprising a hole; and
a sleeve coupled to the plate.

5. The pet toy as claimed in claim 4, wherein the tube further comprises at least one extension coupled to the sleeve.

6. The pet toy as claimed in claim 5, wherein the tube comprises two extensions.

7. The pet toy as claimed in claim 6, wherein at least one extension gap located between the extensions.

8. The pet toy as claimed in claim 7, wherein two gaps are located between the extensions.

9. The pet toy as claimed in claim 6, wherein one of the extension comprises at least one recess.

10. The pet toy as claimed in claim 5, wherein the tube further comprises a ridge located between the sleeve and the extensions.

11. The pet toy as claimed in claim 10, wherein the ridge comprises a ridge gap.

12. A sound generator, comprising:
a tube; and
a sound maker disposed inside the tube, wherein the sound maker comprises:
a toning wedge comprising at least one fixer; and
a reed comprises at least one reed tab coupled into the at least one fixer.

13. The sound generator as claimed in claim 12, wherein the toning wedge comprises two fixers and the reed comprises two reed tabs.

14. The sound generator as claimed in claim 12, wherein the tube comprises:
a plate comprising a hole; and
a sleeve coupled to the plate.

15. The sound generator as claimed in claim 14, wherein the tube further comprises at least one extension coupled to the sleeve.

16. The sound generator as claimed in claim 15, wherein the tube comprises two extensions.

17. The sound generator as claimed in claim 16, wherein two gaps are located between the extensions.

18. The sound generator as claimed in claim 17, wherein one of the extension comprises at least one recess.

19. The sound generator as claimed in claim 15, wherein the tube further comprises a ridge located between the sleeve and the at least one extension.
